(19) United States
(12) Patent Application Publication
(10) Pub. No.: US 2026/0208213 A1
(43) Pub. Date: Jul. 23, 2026

(54) WATER OUTLET STRUCTURE AND WATER OUTLET DEVICE

(71) Applicant: Xiamen Water Nymph Sanitary Technology Co.,Ltd., Xiamen (CN)

(72) Inventor: Huaqiang ZHOU, Xiamen (CN)

(73) Assignee: Xiamen Water Nymph Sanitary Technology Co.,Ltd., Xiamen (CN)

(21) Appl. No.: 19/568,219

(22) Filed: Mar. 16, 2026

Related U.S. Application Data
(63) Continuation of application No. PCT/CN2024/117665, filed on Sep. 9, 2024.

(30) Foreign Application Priority Data
Sep. 18, 2023 (CN) 202311203351.8

(51) Int. Cl. B05B 1/30

(52) U.S. Cl. CPC B05B 1/3006

(57) ABSTRACT

A water outlet structure and a water outlet device are disclosed. The water outlet device includes a water outlet body and a water outlet structure, where the water outlet structure is rotatably connected to a water outlet end of the water outlet body. The water outlet structure includes a first water passing member, a second water passing member, and an elastic member, where the first water passing member is provided with at least one first through hole; the second water passing member is provided with at least one second through hole; a water passing cavity is formed between the first water passing member and the second water passing member, and the elastic member is arranged within the water passing cavity; and a variable water passing gap is formed between the elastic member and at least one of the first through hole and the second through hole.

### CROSS-REFERENCE TO RELATED APPLICATIONS

This application is a continuation application of International Patent Application No. PCT/CN2024/117665, filed on Sep. 9, 2024, which claims priority to Chinese Patent Application No. 202311203351.8, filed on Sep. 18, 2023. The disclosures of the above-mentioned applications are hereby incorporated by reference in their entireties.

### TECHNICAL FIELD

The present disclosure relates to water outlet devices, and in particular, to a water outlet structure and a water outlet device.

### BACKGROUND

In sanitary ware products, to ensure that finally discharged water flows can meet the water usage requirements of preset patterns and application scenarios, and especially must meet the flow discharge standards established by different countries and regions for sanitary ware products, a flow rate control device is typically required to be provided upstream of a water outlet position of a sanitary ware product. For example, by providing a flow rate controller (also known as a flow rate regulator, water saving disc, water conserving disc, or flow restrictor, etc.) in a faucet and a showerhead, the flow rate can be limited or even kept constant.

Some existing water outlet devices feature a rotatable water outlet structure. However, since the discharged water flows from different water outlet surfaces have different flow rate requirements for the upstream input water flow, existing flow rate control devices cannot meet corresponding flow rate control requirements of rotatable water outlet structures.

### SUMMARY

The present disclosure relates to a water outlet structure, including a first water passing member, a second water passing member, and an elastic member, where
the first water passing member is provided with at least one first through hole;
the second water passing member is provided with at least one second through hole;
a water passing cavity is formed between the first water passing member and the second water passing member, and the elastic member is arranged within the water passing cavity; and
at least one of the first through hole and the second through hole is positioned opposite to the elastic member, and a variable water passing gap is formed between the elastic member and at least one of the first through hole and the second through hole.

The present disclosure further relates to a water outlet device, including a water outlet body and the water outlet structure as described above, where
the water outlet structure is rotatably connected to a water outlet end of the water outlet body.

The present disclosure further relates to a water outlet device, including a water inlet body and the water outlet structure as described above, where

the water outlet structure is detachably connected to a water inlet end of the water inlet body.

### BRIEF DESCRIPTION OF THE DRAWINGS

FIG. 1 is a first schematic structural diagram of a water outlet structure according to some embodiments of the present disclosure;

FIG. 2 is a second schematic structural diagram of a water outlet structure according to some embodiments of the present disclosure;

FIG. 3 is a first schematic structural diagram of a water outlet structure according to some embodiments of the present disclosure;

FIG. 4 is a second schematic structural diagram of a water outlet structure according to some embodiments of the present disclosure;

FIG. 5 is a first schematic structural diagram of a water outlet structure according to some embodiments of the present disclosure;

FIG. 6 is a second schematic structural diagram of a water outlet structure according to some embodiments of the present disclosure;

FIG. 7 is a first schematic structural diagram of a water outlet structure according to some embodiments of the present disclosure;

FIG. 8 is a second schematic structural diagram of a water outlet structure according to some embodiments of the present disclosure;

FIG. 9 is a first schematic structural diagram of a water outlet structure according to some embodiments of the present disclosure;

FIG. 10 is a second schematic structural diagram of a water outlet structure according to some embodiments of the present disclosure;

FIG. 11 is a third schematic structural diagram of a water outlet structure according to some embodiments of the present disclosure;

FIG. 12 is a fourth schematic structural diagram of a water outlet structure according to some embodiments of the present disclosure;

FIG. 13 is a first schematic structural diagram of a water outlet structure according to some embodiments of the present disclosure; and

FIG. 14 is a second schematic structural diagram of a water outlet structure according to some embodiments of the present disclosure.

### DETAILED DESCRIPTION OF THE EMBODIMENTS

To elaborate on the technical contents, objectives, and effects of the present disclosure, the following description is provided in conjunction with the embodiments and the accompanying drawings.

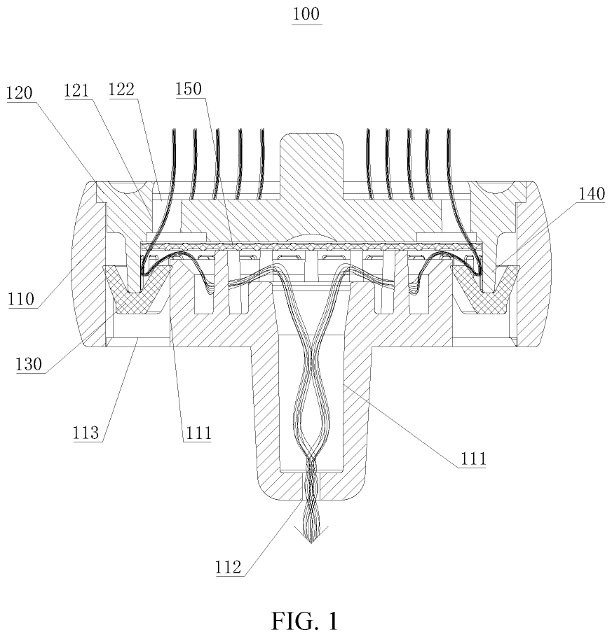

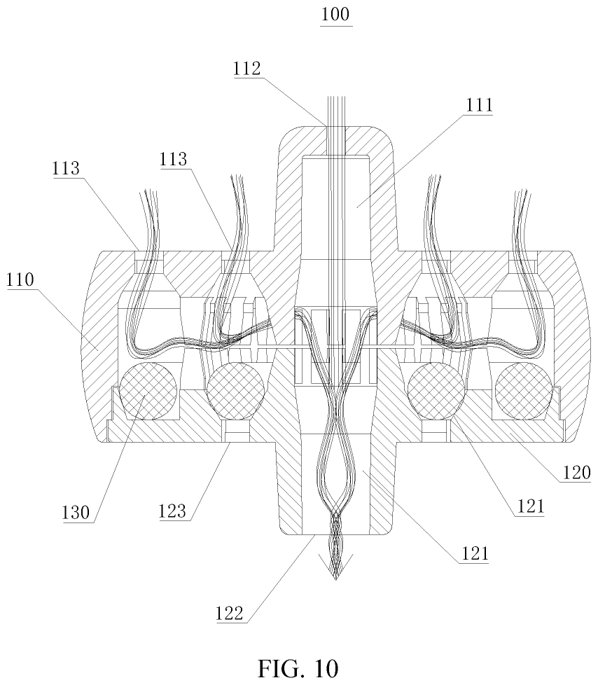

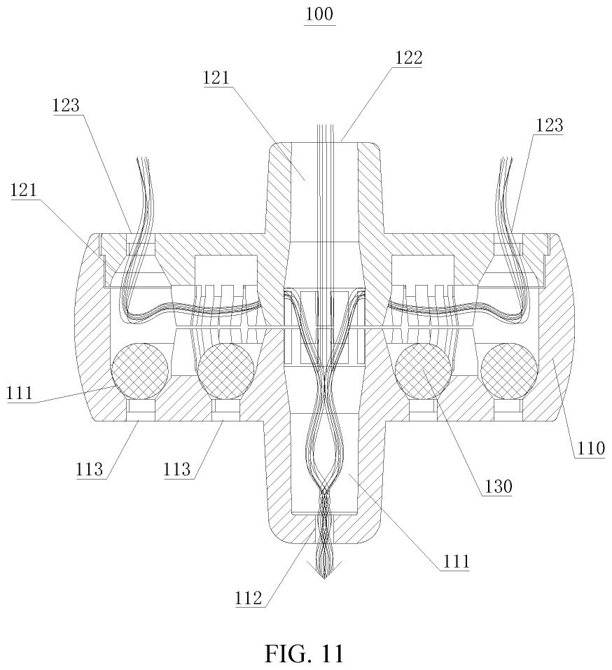

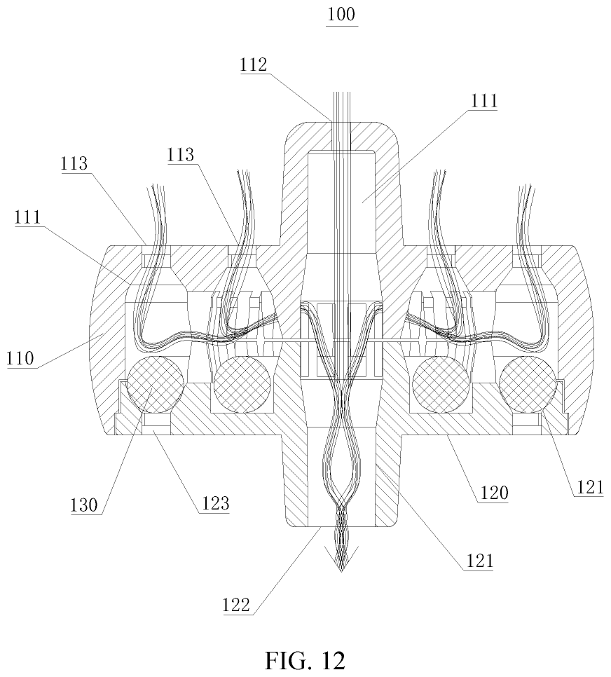

Referring to FIGS. 1 to 14, a water outlet device includes a water outlet body and a water outlet structure 100. The water outlet structure 100 is rotatably connected to a water outlet end of the water outlet body, and the water outlet structure 100 is rotatable about an axis perpendicular to a water flow direction and passing through the water outlet structure 100. Specifically, the water outlet structure 100 includes a first water passing member 110, a second water passing member 120, and an elastic member 130. The first water passing member 110 is provided with at least one first through hole 111. The second water passing member 120 is provided with at least one second through hole 121. A water passing cavity 101 is formed between the first water passing member 110 and the second water passing member 120, and the elastic member 130 is arranged within the water passing cavity. At least one of the first through hole 111 and the second through hole 121 is positioned opposite to the elastic member 130, and a variable water passing gap is formed between the elastic member 130 and at least one of the first through hole 111 and the second through hole 121. When the elastic member 130 deforms or a relative position between the elastic member 130 and at least part of the first through holes 111 or at least part of the second through holes 121 changes, a total water passing area of the first through holes 111 or a total water passing area of the second through holes 121 is changed.

All water passing ports in the first water passing member 110 are located within the corresponding first through holes 111, and all water passing ports in the second water passing member 120 are located at an end portion of the corresponding second through holes 121. During the flipping process, the first water passing member 110 serves as a water inlet side or a water outlet side. When the first water passing member 110 serves as the water inlet side, the second water passing member 120 serves as the water outlet side, and when the first water passing member 110 serves as the water outlet side, the second water passing member 120 serves as the water inlet side.

Another water outlet device of the present disclosure includes a water inlet body and the water outlet structure 100. The water outlet structure 100 is detachably connected to a water inlet end of the water inlet body. The water outlet structure 100 is threadedly connected, snap-fitted, or interference-fitted to the water inlet end of the water inlet body.

It can be understood that during the flipping process or under the influence of a changing water flow, a position of the elastic member 130 within the water outlet structure 100 will change or the elastic member 130 will undergo deformation (the deformation of the elastic member 130 includes deformation under an external force and restoration after the external force is removed), thereby changing the total water passing areas of the first through holes 111 and the second through holes 121. That is, a water passing area of the first through hole 111 or the second through hole 121 may be changed, or the water passing areas of both the first through hole 111 and the second through hole 121 may be changed, thus achieving flow rate control. Therefore, the water outlet structure 100 and the water outlet device of the present disclosure can not only change the water outlet surface to form different water spray patterns but also achieve flow rate regulation.

In some embodiments, an outer surface of the water outlet structure 100 has a partially spherical shape, allowing the water outlet structure to fit with a water outlet body having a spherical socket. Alternatively, the outer surface of the water outlet structure may be provided with threads for direct connection to a water outlet of a faucet, or the water outlet structure may be installed at a water inlet of a showerhead or a water outlet of a shower as a flow rate controller, to change the water discharge state of the showerhead or the shower by switching between the water inlet side and the water outlet side. Alternatively, an outer side wall of the water outlet structure is straight cylindrical or arc-shaped.

In some embodiments, the elastic member 130 can be separated from or pressed against a side wall of the first through hole 111. When the elastic member 130 deforms, the elastic member 130 can be separated from or pressed against the side wall of the first through hole 111, to change the water passing area of the first through hole 111, and then change the total water passing areas of the first through holes 111 and the second through holes 121.

In some embodiments, a position of the elastic member 130 can be changed in an axial direction of the water outlet structure 100. Specifically, the elastic member 130 has a first position and a second position in the axial direction of the water outlet structure 100, and the switching between the first position and the second position is triggered by the flipping of the water outlet structure 100.

In some embodiments, the water passing areas of at least two first through holes 111 or at least two second through holes 121 can be simultaneously changed by one elastic member 130, to ensure a constant water flow during discharge while guaranteeing the effectiveness of changes in water passing areas, thereby ensuring effective flow rate regulation and water spray pattern formation. When the water passing area of one of the first through hole 111 and the second through hole 121 is changed, the total water passing areas of the first through holes 111 and the second through holes 121 may be changed accordingly.

In some embodiments, when the elastic member 130 is pressed against an opening of the first through hole 111 and/or the second through hole 121 facing the water passing cavity, the elastic member 130 is located in the first position, the water passing area of the first through hole 111 and/or the second through hole 121 is at a minimum, and the elastic member 130 is pressed against an inner wall of the first through hole 111. Optionally, the inner wall of the first through hole 111 and/or the second through hole 121 may be smooth or may be provided with a through slot. When the inner wall of the first through hole 111 and/or the second through hole 121 is smooth, the elastic member 130 is pressed against the inner wall of the first through hole 111 and/or the second through hole 121, making the water passing area of the first through hole 111 and/or the second through hole 121 zero; while when a surface of the first through hole 111 and/or the second through hole 121 is provided with a through slot, a small amount of water flows through a gap between the elastic member 130 and the through slot, resulting in a relatively small water passing area.

In some embodiments, when the elastic member 130 deforms or when the elastic member 130 moves toward the second water passing member 120, the elastic member 130 is pressed against the second water passing member 120. When the elastic member 130 moves toward the second water passing member 120, the elastic member 130 can move to the second position and block at least one second through hole 121. Conversely, when an original position of the elastic member 130 is on the side closer to the second water passing member 120, and the elastic member 130 deforms or the elastic member 130 moves toward the first water passing member 110, the elastic member 130 is pressed against the first water passing member 110. When the elastic member 130 moves toward the first water passing member 110, the elastic member 130 can move to the first position and block at least one first through hole 111.

In some embodiments, an insert 140 is further arranged between the first water passing member 110 and the second water passing member 120. When the elastic member 130 deforms or when the elastic member 130 moves toward the first water passing member 110 or the second water passing member 120, the elastic member 130 is pressed against the insert 140. The support provided by the insert 140 for the elastic member 130 allows a water passing gap to be maintained between the elastic member 130 and each of the first water passing member 110 and the second water passing member 120, thereby maximizing the water flow areas. Conversely, when the original position of the elastic member 130 is on the side closer to the second water passing member 120, and the elastic member 130 deforms or the elastic member 130 moves toward the first water passing member 110, the elastic member 130 is pressed against the insert 140. The insert 140 is a boss, a flow straightening mesh, or a flow straightening grid.

In some embodiments, two sides in an axial direction of the water outlet structure 100 are provided with a first water passing port 112 and a second water passing port 122 capable of communicating with the first water passing port 112 respectively. Specifically, the first water passing port 112 is located in the first water passing member 110, and the second water passing port 122 is located in the second water passing member 120. The first water passing port 112 is located in one of the first through holes 111, and the second water passing port 122 is located in one of the second through holes 121. In a radial direction of the water outlet structure 100, a cross-sectional shape of the first water passing port 112 is different from that of the second water passing port 122, so that the water flow has different water discharge states when flowing out from different water passing ports. Additionally, the first water passing member 110 is further provided with a third water passing port 113 capable of communicating with the second water passing port 122. Similarly, the third water passing port 113 is located in another one first through hole 111.

In some embodiments, the elastic member 130 is annular, and any end of an axial cross-section of the elastic member 130 is circular, U-shaped, or Y-shaped. When the elastic member 130 has different structures, its deformation amount and the position change it undergoes are different. Specifically, when any end of the axial cross-section of the elastic member 130 is U-shaped or Y-shaped, the deformation amount of the elastic member 130 during deformation is the largest, and the deformation of the elastic member 130 is sufficient to cause a change in the water flow area, so its position change within the water outlet structure 100 is at a minimum. When any end of the axial cross-section of the elastic member 130 is circular, the deformation amount of the elastic member 130 during deformation is the smallest. To ensure a change in the water flow area, it is required to change the position of the elastic member, thus experiencing the maximum position change within the water outlet structure 100.

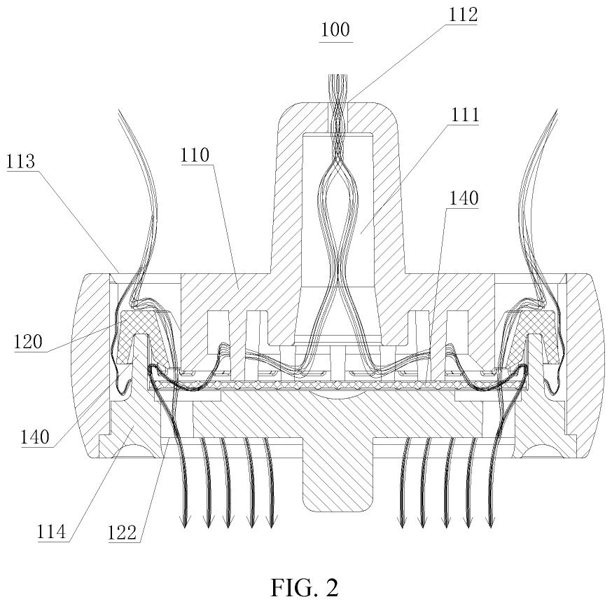

Referring to FIG. 1 and FIG. 2, at least one embodiment of the present disclosure is as follows:

The water outlet structure 100 includes a first water passing member 110, a second water passing member 120, and an elastic member 130. The water outlet structure 100 is provided with a first through hole 111 and a second through hole 121. The elastic member 130 is arranged within the first through hole 111. When the elastic member 130 deforms, a change in a water passing area of the first through hole 111 results in a change in total water passing areas of the first through hole 111 and the second through hole 121.

A water passing cavity is formed between the first water passing member 110 and the second water passing member 120. An insert 140 is further arranged between the first water passing member 110 and the second water passing member 120, and the insert 140 is a boss. Moreover, a water filter mesh 150 is arranged on the second water passing member 120. Two sides in an axial direction of the water outlet structure 100 are provided with a first water passing port 112 and a second water passing port 122 capable of communicating with the first water passing port 112 respectively. Specifically, the first water passing port 112 is located in the first water passing member 110, and the second water passing port 122 is located in the second water passing member 120. Additionally, the first water passing member 110 is further provided with a third water passing port 113 capable of communicating with the second water passing port 122.

The first water passing port 112 and the third water passing port 113 are located in the corresponding first through holes 111 respectively, while the second water passing port 122 is located in the second through hole 121.

Any end of an axial cross-section of the elastic member 130 is Y-shaped. Specifically, when the first water passing member 110 serves as a water outlet side, the elastic member 130 is located in a first position. In this case, the elastic member 130 is pressed against an inner wall of the first through hole 111 to block the third water passing port 113, so water flows in from the second water passing port 122 of the second water passing member 120 and out from the first water passing port 112 (i.e., out from the first through hole 111), achieving high-pressure water discharge with a small area. After the water outlet structure 100 is flipped 180°, the first water passing member 110 serves as a water inlet side. In this case, under the impact of the water flow, the elastic member 130 is pressed against the insert 140, that is, the elastic member 130 is located in a second position. Moreover, the elastic member 130 deforms in a radial direction of the water outlet structure 100. The second through hole 121 communicates with the first through hole 111, that is, water flows in from the first water passing port 112 and the third water passing port 113 and out from the second water passing port 122, achieving large-area water discharge. During the flipping process of the water outlet structure 100, due to the deformation of the elastic member 130 and the slight position change of the elastic member 130, the water passing area of the first through hole 111 is changed, and the total water passing areas of the first through holes 111 and the second through holes 121 are increased. Moreover, since a cross-sectional area of the first water passing port 112 is larger than that of the second water passing port 122, the water pressure and the water spray pattern during water discharge are also changed.

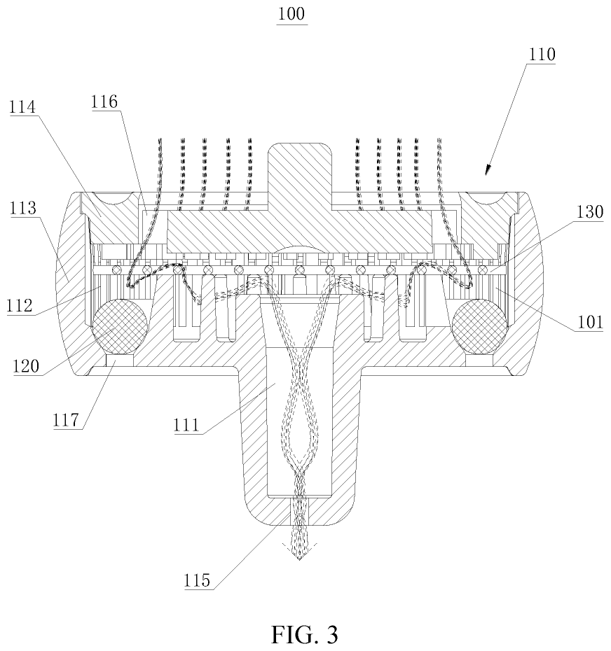

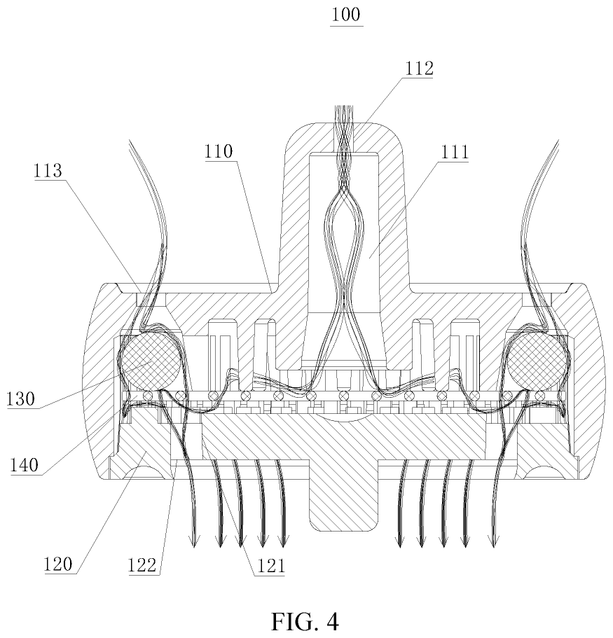

Referring to FIG. 3 and FIG. 4, in some other embodiments, the structures of the elastic member 130, the first water passing member 110, and the second water passing member 120 are different.

The water outlet structure 100 includes a first water passing member 110, a second water passing member 120, and an elastic member 130. The first water passing member 110 is provided with at least one first through hole 111, and the second water passing member 120 is provided with at least one second through hole 121. The elastic member 130 is arranged within the first through hole 111. When a position of the elastic member 130 within the first through hole 111 changes, total water passing areas of the first through holes 111 and the second through holes 121 are changed.

A water passing cavity is formed between the first water passing member 110 and the second water passing member 120. An insert 140 is a flow straightening mesh, which serves to filter impurities in water and support the elastic member 130. Two sides in an axial direction of the water outlet structure 100 are provided with a first water passing port 112 and a second water passing port 122 capable of communicating with the first water passing port 112 respectively. Specifically, the first water passing port 112 is located in the first water passing member 110, and the second water passing port 122 is located in the second water passing member 120. Additionally, the first water passing member 110 is further provided with a third water passing port 113 capable of communicating with the second water passing port 122.

The first water passing port 112 and the third water passing port 113 are located in the corresponding first through holes 111 respectively, while the second water passing port 122 is located in the second through hole 121.

Any end of an axial cross-section of the elastic member 130 is circular. Specifically, when the first water passing member 110 serves as a water outlet side, the elastic member 130 is located in a first position. In this case, the elastic member 130 is pressed against an inner wall of the second through hole 121 to block the third water passing port 113, so water flows in from the second water passing port 122 of the second water passing member 120 and out from the first water passing port 112 (i.e., out from the first through hole 111), achieving high-pressure water discharge with a small area. After the water outlet structure 100 is flipped 180°, the first water passing member 110 serves as a water inlet side. In this case, under the impact of the water flow, the elastic member 130 is pressed against the insert 140, that is, the elastic member 130 is located in a second position. Moreover, the elastic member 130 slightly deforms. The second through hole 121 communicates with the first through hole 111, that is, water flows in from the first water passing port 112 and the third water passing port 113 and out from the second water passing port 122, achieving large-area water discharge. During the flipping process of the water outlet structure 100, due to the position change of the elastic member 130, a water passing area of the second through hole 121 is changed, and the total water passing areas of the first through holes 111 and the second through holes 121 are increased. Moreover, since a cross-sectional area of the first water passing port 112 is larger than that of the second water passing port 122, the water pressure and the water spray pattern during water discharge are also changed.

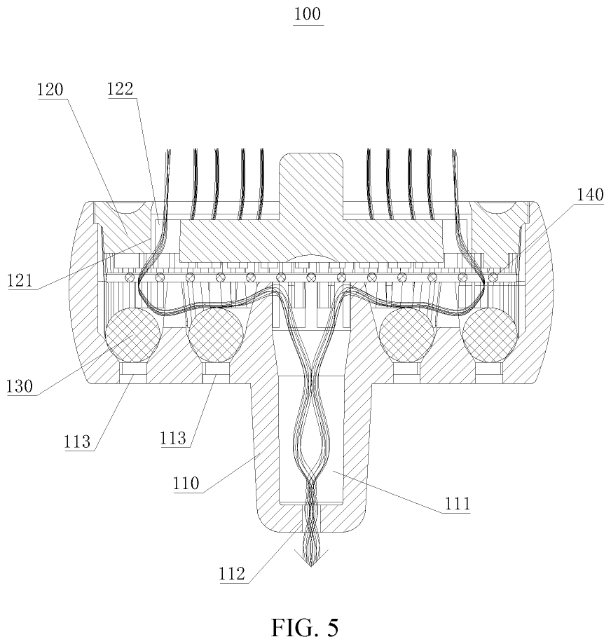

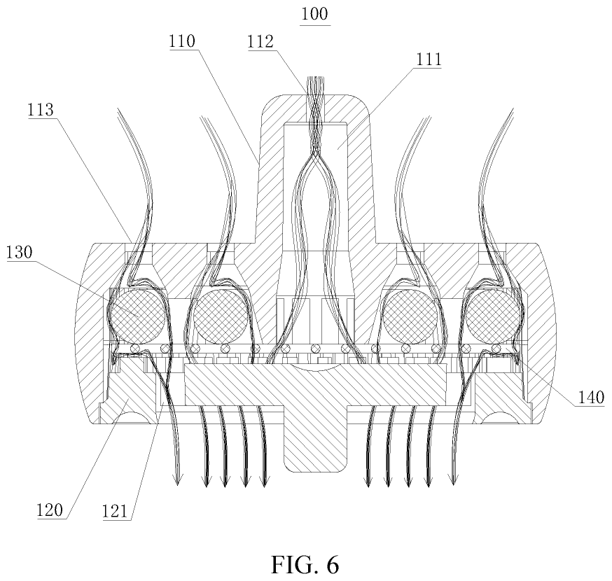

Referring to FIG. 5 and FIG. 6, in some other embodiments, two elastic members 130 and two third water passing ports 113 which are coaxially arranged but have different diameters are provided.

The water outlet structure includes a first water passing member 110 and a second water passing member 120 which are coaxially arranged, and elastic members 130. The first water passing member 110 is provided with at least one first through hole 111, and the second water passing member 120 is provided with at least one second through hole 121. The elastic members 130 are arranged within the second through holes 121. When positions of the elastic members 130 within the second through holes 121 change, total water passing areas of the first through holes 111 and the second through holes 121 are changed.

A water passing cavity is formed between the first water passing member 110 and the second water passing member 120. An insert 140 is arranged between the first water passing member 110 and the second water passing member 120, and the insert 140 is a flow straightening mesh. Two sides in an axial direction of the water outlet structure 100 are provided with a first water passing port 112 and a second water passing port 122 capable of communicating with the first water passing port 112 respectively. Specifically, the first water passing port 112 is located in the first water passing member 110, and the second water passing port 122 is located in the second water passing member 120. Additionally, the first water passing member 110 is further provided with third water passing ports 113 capable of communicating with the second water passing port 122.

The first water passing port 112 and the third water passing ports 113 are located in the corresponding first through holes 111 respectively, while the second water passing port 122 is located in the second through hole 121.

Any end of an axial cross-section of the elastic member 130 is circular. Specifically, when the first water passing member 110 serves as a water outlet side, the elastic members 130 are located in a first position. In this case, the elastic members 130 are pressed against inner walls of the first through holes 111 to block the third water passing ports 113, so water flows in from the second water passing port 122 of the second water passing member 120 and out from the first water passing port 112 (i.e., out from the first through hole 111), achieving high-pressure water discharge with a small area. After the water outlet structure 100 is flipped 180°, the first water passing member 110 serves as a water inlet side. In this case, under the impact of the water flow, the elastic members 130 are pressed against the insert 140, that is, the elastic members 130 are located in a second position. Moreover, the elastic members 130 slightly deform. The first through hole 111 communicates with the second through hole 121, that is, water flows in from the first water passing port 112 and the two third water passing ports 113 and out from the second water passing port 122, achieving large-area water discharge. During the flipping process of the water outlet structure 100, due to the position change of the elastic members 130, a water passing area of the first through hole 111 is changed, and the total water passing areas of the first through holes 111 and the second through holes 121 are increased. Moreover, since a cross-sectional area of the first water passing port 112 is larger than that of the second water passing port 122, the water pressure and the water spray pattern during water discharge are also changed.

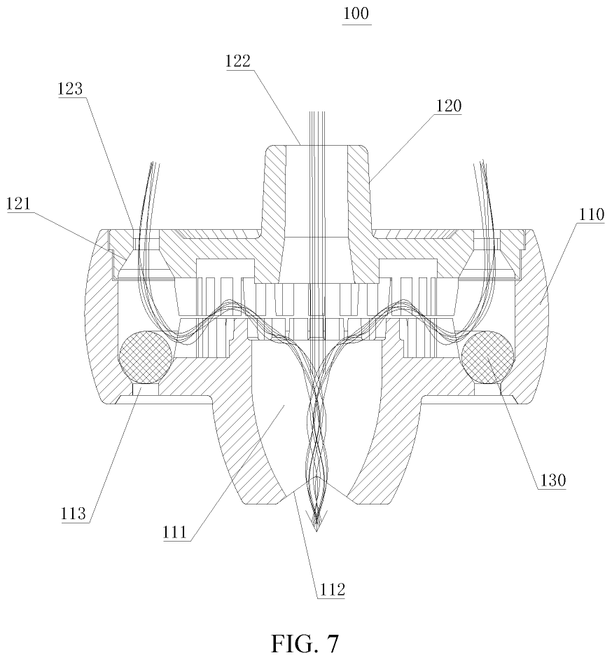

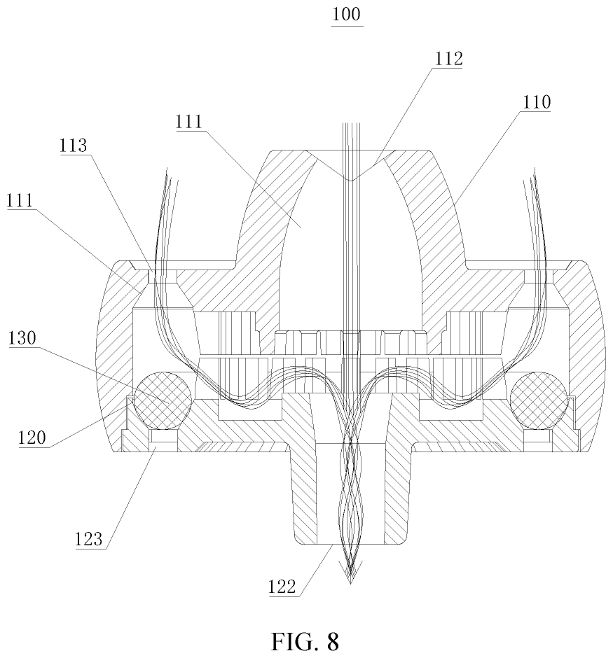

Referring to FIG. 7 and FIG. 8, in some other embodiments, the water outlet structure 100 includes a first water passing member 110, a second water passing member 120, and an elastic member 130. The first water passing member 110 is provided with at least one first through hole 111, and the second water passing member 120 is provided with at least one second through hole 121. The elastic member 130 is arranged within the second through hole 121.

A water passing cavity is formed between the first water passing member 110 and the second water passing member 120. Two sides in an axial direction of the water outlet structure 100 are provided with a first water passing port 112 and a second water passing port 122 capable of communicating with the first water passing port 112 respectively. Specifically, the first water passing port 112 is located in the first water passing member 110, the second water passing port 122 is located in the second water passing member 120, and the first water passing port 112 and the second water passing port 122 are coaxially arranged. Additionally, the first water passing member 110 is further provided with a third water passing port 113, and the second water passing member 120 is further provided with a fourth water passing port 123.

Any end of an axial cross-section of the elastic member 130 is circular. Specifically, when the first water passing member 110 serves as a water outlet side, the elastic member 130 is located in a first position. In this case, the elastic member 130 is pressed against one end of an inner wall of the first through hole 111 to block the third water passing port 113, so water flows in from the second water passing port 122 of the second water passing member and the fourth water passing port 123 and out from the first water passing port 112 (i.e., out from the first through hole 111), forming a first high-pressure water spray pattern, i.e., high-pressure columnar water. After the water outlet structure 100 is flipped 180°, the first water passing member 110 serves as a water inlet side. In this case, under the impact of the water flow, the elastic member 130 is pressed against an end of an inner wall of the second through hole 121 to block the fourth water passing port 123, that is, the elastic member 130 is located in a second position, so water flows in from the first water passing port 112 and the third water passing port 113 and out from the second water passing port 122, forming a second high-pressure water spray pattern, i.e., blade-shaped water. During the flipping process of the water outlet structure 100, due to the position change of the elastic member 130, water flows out from water passing ports with different shapes. As a result, the water spray pattern is changed during water discharge. The water spray pattern depends on cross-sectional shapes of the first water passing port 112 and the second water passing port 122. In addition to the two water spray patterns mentioned above, other water spray patterns can also be formed.

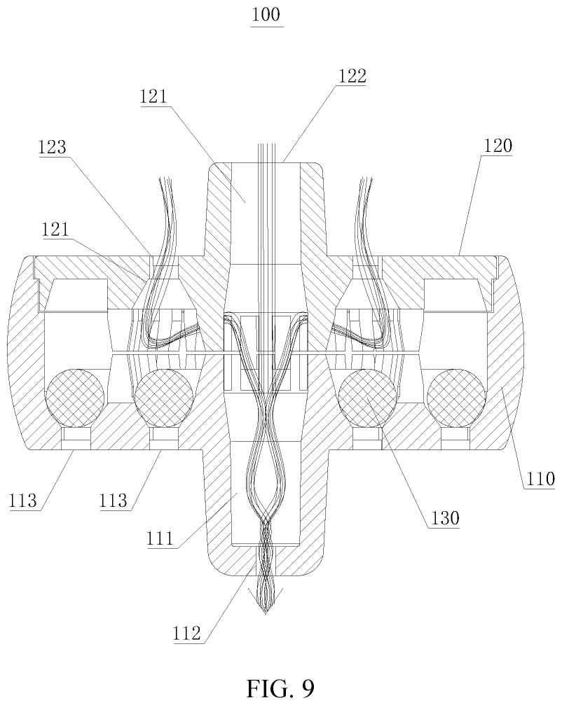

Referring to FIG. 9 to FIG. 12, in some other embodiments, the insert 140 is not provided.

The water outlet structure 100 includes a first water passing member 110, a second water passing member 120, and elastic members 130. The first water passing member 110 is provided with at least one first through hole 111, and the second water passing member 120 is provided with at least one second through hole 121. The elastic members 130 are arranged within the second through holes 121. When positions of the elastic members 130 within the second through holes 121 change, total water passing areas of the first through holes 111 and the second through holes 121 are changed.

A water passing cavity is formed between the first water passing member 110 and the second water passing member 120. Two sides in an axial direction of the water outlet structure 100 are provided with a first water passing port 112 and a second water passing port 122 capable of communicating with the first water passing port 112 respectively. Specifically, the first water passing port 112 is located in the first water passing member 110, and the second water passing port 122 is located in the second water passing member 120. Additionally, the first water passing member 110 is further provided with two third water passing ports 113, and the second water passing port 122 is further provided with a fourth water passing port 123.

The first water passing port 112 and the third water passing ports 113 are located in the corresponding first through holes 111 respectively, while the second water passing port 122 and the fourth water passing port 123 are located in the corresponding second through holes 121 respectively.

Any end of an axial cross-section of the elastic member 130 is circular. Specifically, when the first water passing member 110 serves as a water outlet side, the elastic members 130 are located in a first position. In this case, the elastic members 130 are pressed against inner walls of the first through holes 111 to block the third water passing ports 113, so water flows in from the second water passing port 122 of the second water passing member 120 and the fourth water passing port 123 and out from the first water passing port 112 (i.e., out from the first through hole 111), forming a first high-pressure water spray pattern, i.e., high-pressure columnar water. After the water outlet structure 100 is flipped 180°, the first water passing member 110 serves as a water inlet side. In this case, under the impact of the water flow, the elastic members 130 are pressed against inner walls of the second through holes 121 to block the fourth water passing port 123, that is, the elastic members 130 are located in a second position, so water flows in from the first water passing port 112 and the third water passing ports 113 and out from the second water passing port 122, forming a second high-pressure water spray pattern, i.e., blade-shaped water. During the flipping process of the water outlet structure 100, due to the position change of the elastic members 130, water passing areas of the first through hole 111 and the second through hole 121 are changed. Specifically, the path that water flows in from one fourth water passing port 123 and out from the first water passing port 112 is changed to a path that water flows in from at least two third water passing ports 113 and out from the second water passing port 122, causing that water flows out from water passing ports with different shapes. As a result, the water spray pattern is changed during water discharge. The water spray pattern depends on cross-sectional shapes of the first water passing port 112 and the second water passing port 122. In addition to the two water spray patterns mentioned above, other water spray patterns can also be formed.

The fourth water passing port 123 can be provided at a position opposite to the third water passing port 113 or can be provided in a staggered manner with the third water passing port 113 in the axial direction of the water outlet structure 100.

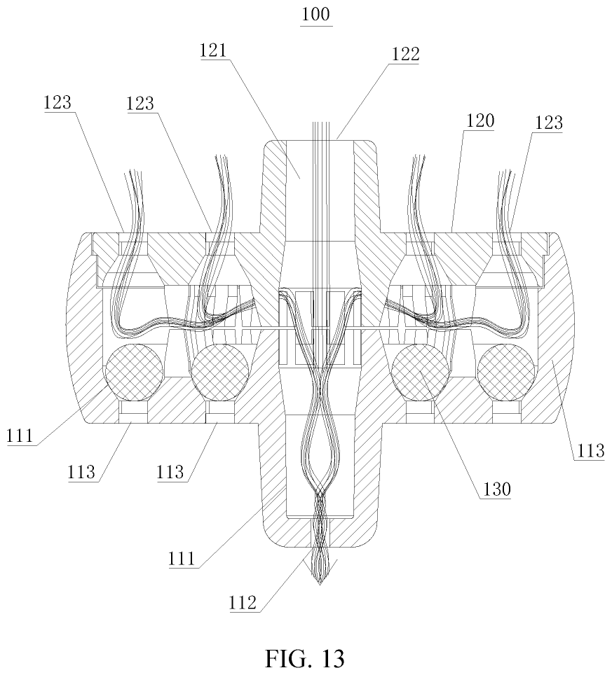

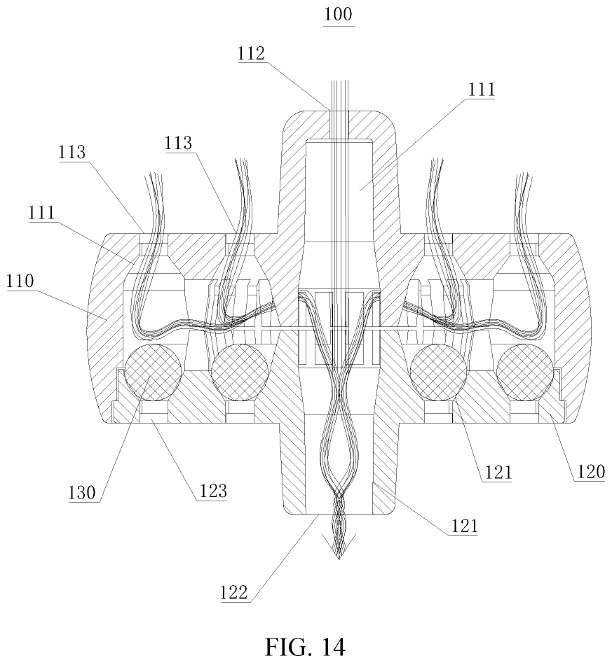

Referring to FIG. 13 and FIG. 14, in some other embodiments, two coaxially arranged fourth water passing ports 123 are provided.

The above descriptions are merely embodiments of the present disclosure and do not limit the patent scope of the present disclosure. Any equivalent transformations made or direct or indirect applications in related technical fields using the content of the specification and drawings of the present disclosure are included within the patent protection scope of the present disclosure.

What is claimed is:

1. A water outlet structure, comprising: a first water passing member, a second water passing member, and an elastic member, wherein
the first water passing member is provided with at least one first through hole;
the second water passing member is provided with at least one second through hole;
a water passing cavity is formed between the first water passing member and the second water passing member, and the elastic member is arranged within the water passing cavity; and
at least one of the first through hole or the second through hole is positioned opposite to the elastic member, and a variable water passing gap is formed between the elastic member and at least one of the first through hole and the second through hole.

2. The water outlet structure according to claim 1, wherein the elastic member is provided with a sealing portion, and the sealing portion is pressed against a side wall of the first through hole.

3. The water outlet structure according to claim 1, wherein the elastic member is provided with a sealing portion, and the water passing gap is formed between the sealing portion and a side wall of the first through hole.

4. The water outlet structure according to claim 1, wherein when the elastic member is pressed against an opening of at least one of the first through hole or the second through hole facing the water passing cavity, the water passing area of the first through hole or the second through hole is at a minimum.

5. The water outlet structure according to claim 1, wherein an insert is further arranged between the first water passing member and the second water passing member; and
when the elastic member is pressed against the insert, the water passing gap is formed between the elastic member and a side wall of the first through hole.

6. The water outlet structure according to claim 4, wherein the insert is a boss, a flow straightening mesh, or a flow straightening grid.

7. The water outlet structure according to claim 1, wherein two sides in an axial direction of the water outlet structure are provided with a first water passing port and a second water passing port respectively; and
in a radial direction of the water outlet structure, a cross-sectional shape of the first water passing port is different from that of the second water passing port.

8. The water outlet structure according to claim 1, wherein the first water passing member is provided with a third water passing port, and the second water passing member is provided with a fourth water passing port;
the third water passing port is formed by ends of some of the first through holes, and the fourth water passing port is formed by ends of some of the second through holes; and
the elastic member is embedded in the first through hole that forms the third water passing port.

9. The water outlet structure according to claim 8, wherein the elastic member is embedded in the second through hole that forms the fourth water passing port.

10. The water outlet structure according to claim 1, wherein an outer side wall of the water outlet structure is straight cylindrical or arc-shaped.

11. The water outlet structure according to claim 1, wherein an outer side wall of the water outlet structure is provided with threads.

12. The water outlet structure according to claim 1, wherein the elastic member is annular, and any end of an axial cross-section of the elastic member is circular, U-shaped, or Y-shaped.

13. A water outlet device, comprising: a water outlet body and the water outlet structure according to claim 1, wherein
the water outlet structure is rotatably connected to a water outlet end of the water outlet body.

14. The water outlet device according to claim 13, wherein the water outlet structure is rotatable about an axis perpendicular to a water flow direction and passing through the water outlet structure.

15. A water outlet device, comprising: a water inlet body and the water outlet structure according to claim 1, wherein
the water outlet structure is detachably connected to a water inlet end of the water inlet body.

16. The water outlet device according to claim 15, wherein the water outlet structure is threadedly connected, snap-fitted, or interference-fitted to the water inlet end of the water inlet body.
